(19) United States
(12) Patent Application Publication
(10) Pub. No.: US 2009/0244624 A1
(43) Pub. Date: Oct. 1, 2009

(54) PRINTER AND ITS CONTROLLING METHOD

(75) Inventor: Masakatsu ENDO, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Shinjuku-Ku (JP)

(21) Appl. No.: 12/481,415

(22) Filed: Jun. 9, 2009

Related U.S. Application Data
(63) Continuation of application No. 10/492,030, filed on Aug. 16, 2004.

(30) Foreign Application Priority Data
Mar. 14, 2002 (JP) 2002-70879
May 14, 2002 (JP) 2002-139012

(51) Int. Cl. G06F 15/02

(52) U.S. Cl. 358/1.16

(57) ABSTRACT

The printer according to the present invention comprises: a plurality of interfaces for respectively accessing a plurality of storage media having subject data to be printed stored therein; an exclusive controlling element for determining, when access can be made to storage media loaded in two or more interfaces out of the plurality of interfaces, one interface out of the two or more interfaces as a valid interface; an image processing element for reading subject data to be printed from a storage medium loaded in the valid interface determined by the exclusive controlling element; and a printing processing element for printing the subject data that was read by the image processing element. Thus, it is possible to provide a printer having great versatility so that various kinds of storage media can be used therewith and having great usability for individual users.

### CROSS-REFERENCE TO RELATED APPLICATIONS

This is a continuation of U.S. application Ser. No. 10/492,030, filed Apr. 8, 2004, which is a National Stage Entry of PCT/JP03/03096 filed Mar. 14, 2003 and claims priority from Japanese Patent Application No. 2002-70879 filed on Mar. 14, 2002 and Japanese Patent Application No. 2002-139012 filed on May 14, 2002, the contents of which are herein incorporated by reference in their entirety.

### FIELD OF THE INVENTION

The present invention relates to a printer, particularly to a printer executing printing processes by itself.

### BACKGROUND

So-called stand-alone printers have emerged, which can print specific data onto print media by the printer themselves without being connected to host devices such as personal computers.

Such a stand-alone printer has a main body including a control panel for sending printing commands and for defining the printing conditions, and an interface for reading subject data to be printed stored in a storage medium. The printer is typically used for printing image data captured by a digital still camera or the like.

A user inserts a memory card containing image data captured by a digital still camera into a slot of the main body of the stand-alone printer, and uses the control panel to send printing commands to the printer.

Since the conventional stand-alone printer described above has only one slot, it is easy for the user to operate the printer. However, the printer lacks versatility due to the limited number of storage media that can be used therein.

Storage media for storing image data captured by photographic equipment, for example, digital still cameras and digital video cameras, often varies according to the manufacturer of the photographic equipment. Therefore, it is desirable to provide a printer having greater versatility so that different types of storage media can be used in the same printer.

However, even if the number of storage media usable in the same printer is increased, the fact is that most users usually have only one type of photographic equipment and storage medium. Accordingly, it is enough for individual users to use their own storage medium and it is preferable that the operation of the printer be simple.

Therefore, the present invention features a printer having greater versatility so that different types of storage media can be used in the printer, and ensuring a high degree of ease of operation for individual users.

### SUMMARY

In order to achieve the above objects, the present invention provides a printer comprising: a plurality of interfaces for respectively accessing a plurality of storage media having subject data to be printed stored therein; an exclusive controlling element for determining, when access can be made to storage media loaded in two or more interfaces out of the plurality of interfaces, one interface out of the two or more interfaces as a valid interface; an image processing element for reading subject data to be printed from a storage medium loaded in the valid interface determined by the exclusive controlling element; and a printing processing element for printing the subject data that was read by the image processing element.

The exclusive controlling element preferably specifies a valid interface according to priorities given to each of the plurality of interfaces.

When access to the storage medium through the valid interface is disabled, the valid interface preferably switches to another interface.

When an access to another storage medium through a specified interface is enabled, the exclusive controlling element preferably switches the valid interface to the specified interface.

When the power for the printer is turned on, when access can be made to storage media loaded in two or more interfaces out of the plurality of interfaces, the exclusive controlling element preferably determines that an interface having the highest priority is the valid interface.

The printer preferably comprises a display unit which, when one interface is already the valid interface and then access can be made to another interface for accessing the subject data to be printed stored in a storage medium loaded in the other interface, displays a command for switching the valid interface to the other interface.

When an access can be made, through one interface out of the plurality of the interfaces, to a digital camera having a storage medium loaded therein, the exclusive controlling element preferably gives that interface the highest priority.

In order to achieve the above objects, the present invention also provides a printer comprising: a plurality of interfaces for respectively accessing a plurality of storage media having subject data to be printed stored therein; an exclusive controlling element that, during printing process, validates one interface out of two or more interfaces that can be accessed for accessing storage media loaded therein, however, during storage processing, it validates storage processing-related interfaces among the two or more interfaces; an image processing element for reading subject data to be printed from a storage medium and writing the subject data to another storage medium, through the interfaces validated by the exclusive controlling element; and a printing processing element for printing the subject data to be printed that was read by the image processing element.

When subject data to be printed that is stored in a storage medium loaded in a first interface, is stored in a storage medium loaded in a second interface, both the first and second interfaces are preferably validated, and when the image processing element completes the storage of the subject data to be printed, the second interface preferably becomes invalid.

In order to achieve the above objects, the present invention also provides a printer comprising: a plurality of interfaces for respectively accessing a plurality of storage media having subject data to be printed stored therein; an image processing element that, upon receiving a request for storing subject data to be printed, reads the subject data to be printed from a storage medium loaded in one of the plurality of interfaces, and writes the subject data read on another storage medium loaded in another interface; and a printing processing element for printing the subject data to be printed that was read from the storage medium loaded in the interface, wherein, while the printing processing element is printing the subject data to be printed, the image processing element rejects a command for storing the subject data to be printed.

The present invention for achieving the above objects can also be implemented as a method invention. Accordingly, the present invention is a controlling method for a printer, comprising: a step in which, when there are two or more interfaces that are available for accessing storage media having subject data to be printed stored therein, one interface out of the two or more interfaces is validated according to the priorities given to the respective interfaces; and a step in which, when the access to the storage medium through the validated interface is disabled, another interface is validated according to the priorities.

Moreover, the present invention is a controlling method for a printer comprising steps of: receiving a command for storing subject data to be printed; validating a first interface that has a storage medium having the subject data to be printed stored therein, and a second interface that has a storage medium on which the subject data will be stored; reading the subject data to be printed that is stored in the storage medium loaded in the first interface; writing the subject data read on the storage medium loaded in the second interface; and invalidating the second interface.

The above controlling method further comprises steps of: receiving a command for storing the subject data to be printed; and determining whether the subject data to be printed is under the printing process, wherein, when it is determined that the received subject data to be printed is under the printing process, no processing related to storage of the subject data is executed.

The exclusive controlling element may be configured such that, instead of validating one interface, it grants, to the storage medium loaded in the interface, a right to receive an access request from a specified requestor. The image processing element may be configured such that it reads the subject data to be printed from the storage medium that was granted with the right to be accessed.

The present invention is a printer comprising: a plurality of slots to which a plurality of removable storage media having subject data to be printed are inserted; an exclusive controlling element that grants a right to be accessed to one of the plurality of the storage media when there are two or more slots having corresponding storage media loaded therein; an image processing element for reading the subject data to be printed from the storage medium that was granted the right to be accessed; and a printing processing element for printing the subject data to be printed that was read by the image processing element.

It is preferable that the exclusive controlling element grant rights to be accessed to the storage medium according to the priorities given to the plurality of slots.

When the storage medium granted the right to be accessed is removed from the corresponding slot, the exclusive controlling element preferably grants the right to be accessed to another storage medium loaded in another slot.

The printer comprises an external interface to which an external device can be connected, and a removable storage medium storing subject data to be printed therein, can be loaded in the external device. When the right to be accessed is given to the storage medium loaded in the external device and then a storage medium is inserted to the slot, the exclusive controlling element preferably gives the right to be accessed that was originally given to the storage medium loaded in the external device to the storage medium loaded in the slot.

The external interface is characterized in that it has a priority lower than that of the card slot, but when a digital camera is connected to the external interface, the priority of the external interface preferably becomes higher than that of the card slot.

In order to store the subject data to be printed in the card-type storage medium loaded in the card slot, in the storage medium loaded in the external device, the exclusive controlling element grants rights to be accessed to both the storage medium loaded in the card slot and the storage medium loaded in the external device. Then, when the storing of the subject data to be printed is completed, the exclusive controlling element preferably cancels the access given to the storage medium loaded in the external device.

The product invention may be perceived as a method invention and vice versa. Moreover, the present invention may be realized as a program for making a computer realize a specified function and realized as a storage medium having such program stored therein. Examples of the storage medium include hard disks (HD), DVD-RAMs, flexible disks (FD), CD-ROMs, and memory chips such as RAM and ROM. Examples of a computer include the so-called microcomputer in which a so-called central processing unit, such as a CPU and MPU, interprets a program to execute a specified process.

In this specification, means shall not simply refer to a physical means, but includes functions which are realized by software or hardware circuitry. A function of one means may be realized by two or more physical means, likewise, functions of two or more means may be realized by one physical means.

### DESCRIPTION OF DRAWINGS

FIGS. 1A and 1B show external views of a printer according to an embodiment of the present invention.

FIG. 2 is a block diagram indicating a configuration of a printer 1 according to the present embodiment.

FIG. 3 shows priorities given to each interface of the printer 1.

FIG. 4 is a flow chart illustrating the basic operational flow of the printer 1 during the printing process of the printer 1 according to the present embodiment.

FIG. 5 is a flow chart illustrating an operational flow of the printer 1 when powered on.

FIG. 6 is a flow chart illustrating an operational flow of the printer 1 when a storage medium is inserted into a slot.

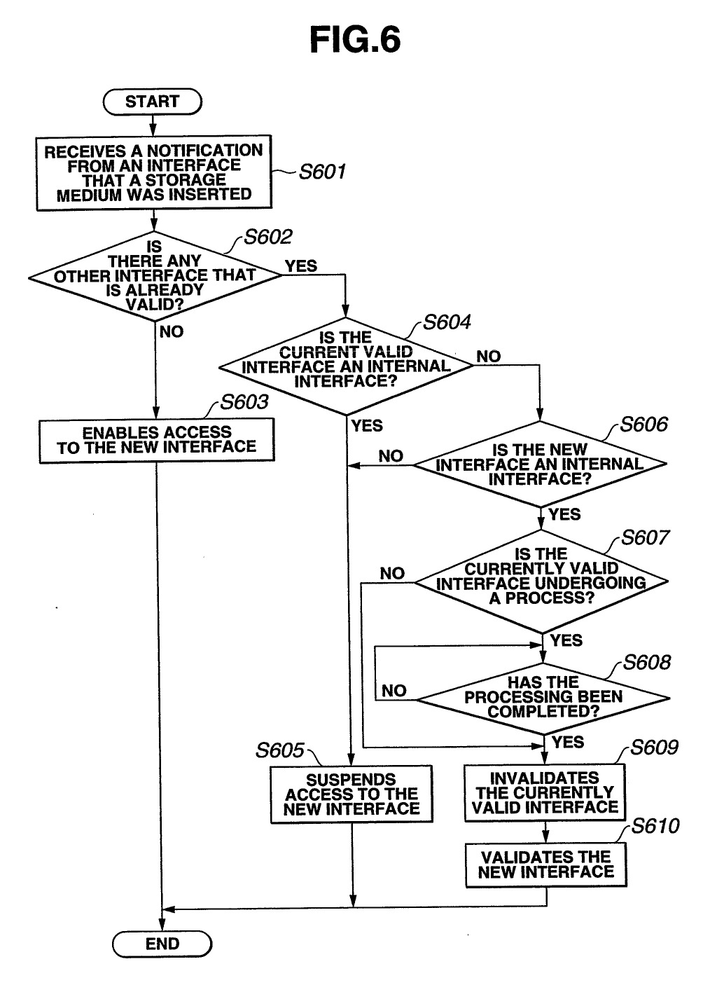

FIG. 7 is a flow chart illustrating an operational flow of the printer 1 when the storage medium is removed from the slot.

FIG. 8 is a flow chart illustrating the basic operational flow of the printer 1 during backup process according to the present embodiment.

FIG. 9 is a flow chart illustrating the basic operational flow of the printer 1 during backup process according to the present embodiment.

FIGS. 10A thru 10C show examples of messages displayed on a preferences menu screen.

### DETAILED DESCRIPTION

Now, an embodiment of the present invention will be explained hereinafter with reference to the drawings.

### [External View of Printer]

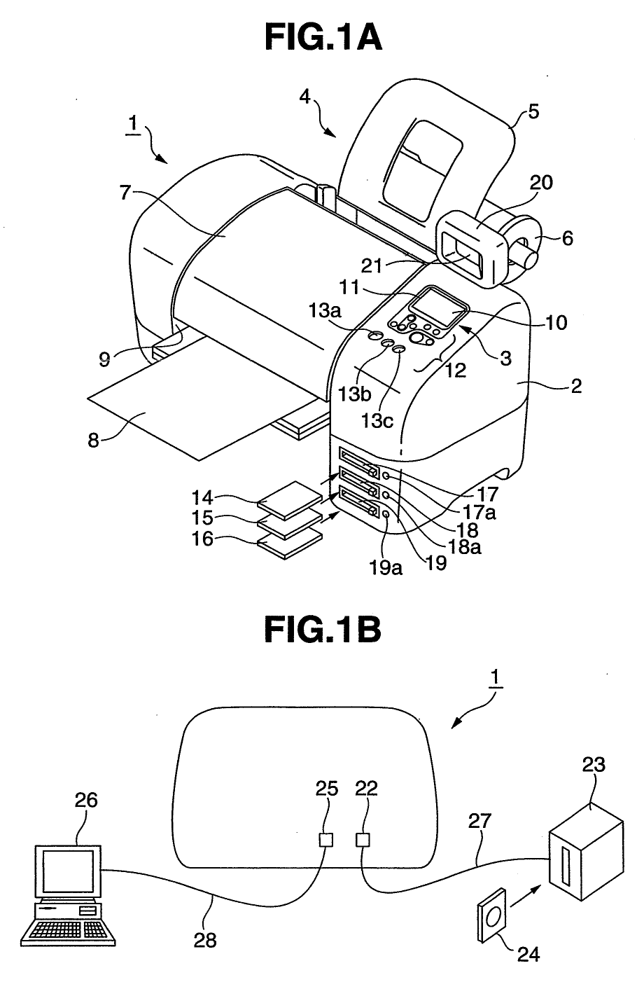

FIG. 1 is an external view of a printer of the present embodiment. FIG. 1 (a) is a perspective view of the printer of the present embodiment, looking from an angle. FIG. 1 (b) is a schematic rear view of the printer of the present embodiment.

A printer 1, a printing system, functions as a stand-alone printer that can print specified data without being connected to a host device. The printer 1 of the present embodiment has plural slots so that it can correspond to plural types of media (storage media). However, the printer 1 employs a configuration wherein a valid slot automatically switches with an insertion/removal of the media as a trigger. Accordingly, the number of slots that can be accessed during the direct printing (in which the printer directly reads, without involving a host device, subject data to be printed from a storage medium inserted in a slot of the printer and prints the subject data) is limited to one.

Referring to FIG. 1 (a), a main body 2 of the printer 1 has a control panel 3 on its top right-hand side. The user can operate the control panel 3 to send various commands, such as commands for printing or for data backup, to the printer. The main body 2 also has a paper supply unit 4 on the back side, such that sheets of paper loaded in a sheet feeder 5 or a roll of paper supported by a roll paper holder 6 is fed into the main body 2. Equipped beneath a cover 7 which is provided at the center of the main body 2, is a printing feature (not shown) that executes the printing process, and when it executes the printing process, a printed sheet of paper 8 is dropped from a paper outlet 9 at the bottom front side of the main body 2.

The control panel 3 comprises a display unit 11 having a preferences menu screen 10, and, as an operational means, an operation unit 12 consisting of plural operation buttons 13a to 13c. The preferences menu screen 10 provides a menu screen for choosing, for example, the type and size of paper, layout, photograph selection, and the number of sets. The preferences menu screen 10 also provides a menu screen for saving (backup) image data stored in the storage media loaded in any of the after-mentioned slots 17 to 19, on a storage medium loaded in an external storage unit 23. The operation unit 12 consists of: a power button 13a to turn on the power; a maintenance button 13b to press in the event of an error; and a roll paper button 13c to adjust the roll paper.

The main body 2 of the printer 1 also has, at its front right-hand side, a first slot 17, a second slot 18, and a third slot 19 as connecting means for connecting a first storage medium 14, a second storage medium 15, and a third storage medium 16 to the printer respectively, the three slots constituting internal interfaces. Located beside the respective slots 17 to 19 are LEDs 17a to 19a, being configured to illuminate when the corresponding slot is a valid slot (slot allowed to access the inserted storage medium). In this embodiment, the first slot 17, the second slot 18, and the third slot 19 are compatible with three different types of storage media, respectively. For example, a CompactFlash corresponds to the first storage medium 14 to be inserted into the first slot 17; a SmartMedia corresponds to the second storage medium 15 to be inserted into the second slot 18; and a Sony Memory Stick corresponds to the third storage medium 16 to be inserted into the third slot 19. The user can properly use any slot from 17 to 19, according to the type of the medium (storage medium) in his/her digital camera or the like.

The printer 1 has, on the top of the main body 2, a display unit (monitor) 20 that displays images read from the respective storage media 14 to 16. When the stand-alone printer prints the image data stored in the storage medium, the user usually cannot preview the image data on a screen of his/her host device as the printer is not connected to the host device. In this invention, however, the images are displayed on a preview screen 21 of the monitor 20 so that the user can preview the images and confirm the print layout without connecting the printer to the host device.

Referring to FIG. 1 (b), provided at the rear side bottom of the main body 2 of the printer 1, as connecting means for connecting the printer 1 to external devices, are ports 22 and 25 constituting external interfaces. The port (for type A USB connectors) 22 connects the external storage unit 23 (for example, magneto-optical disk drive) to the printer 1 through a cable 27. The user inserts a storage medium 24 (for example, a magneto-optical disk) into the external storage unit 23 and manipulates the control panel 3 to send commands to the printer such as a command to directly print the image data stored in the storage medium 24, or a command to store the image data stored in the first storage medium 14, in the storage medium 24 loaded in the external storage 23.

The port 25 (for type B USB connectors) connects a host device 26 to the printer 1 through a cable 28. The host device 26 accesses, through the port 25, the storage media 14 to 16 inserted in the respective slots 17 to 19 as well as the storage medium 24 loaded in the external storage unit 23. The user can send commands to the host device 26 such as a command for reading specified data from the storage media 14 to 16 and 24 or a command for writing specified data on the storage media 14 to 16 and 24.

### [Hardware Configuration]

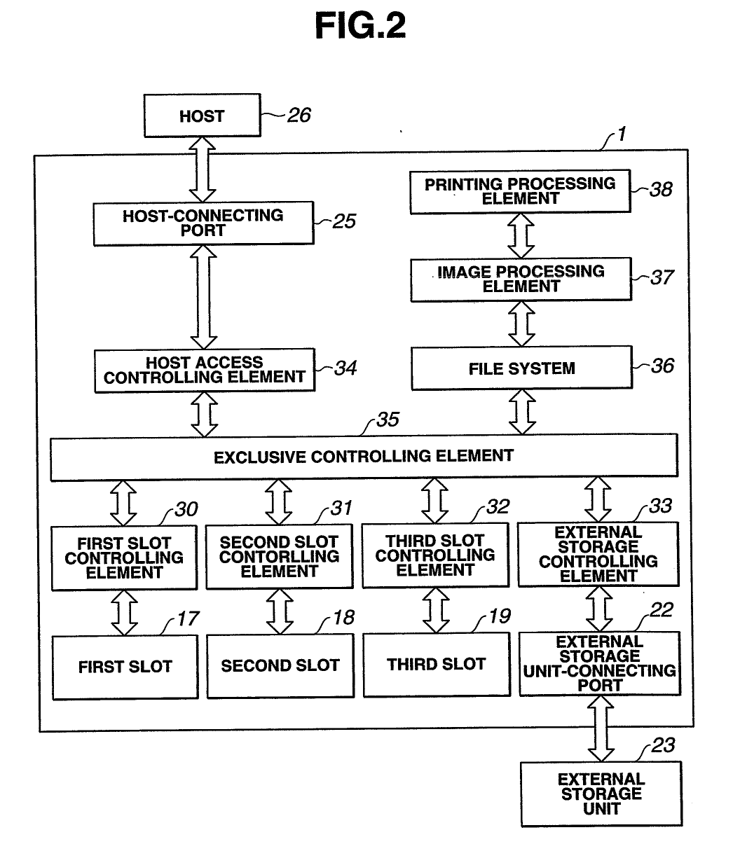

FIG. 2 is a block diagram illustrating the configuration of the printer 1 according to the present embodiment.

Upon detecting that a storage medium is inserted, a first slot controlling element 30, a second slot controlling element 31, and a third slot controlling element 32 respectively perform initialization processing to enable accesses to the respective storage media, and notify that fact to an exclusive controlling element 35.

An external storage controlling element 33, upon detecting that a storage medium was inserted into the external storage unit 23, performs the initialization processing to enable an access to the storage medium and notifies that fact to the exclusive controlling element 35. A host access controlling element 34, upon receiving a request for access from the host device 26 via a host-connecting port 25, notifies receipt of such request to the exclusive controlling element 35.

The exclusive controlling element 35 is connected to the first slot controlling element 30, the second slot controlling element 31, the third slot controlling element 32 and the external storage controlling element 33 (together hereinafter referred to as the “respective controlling elements 30 to 33”). The exclusive controlling element 35 checks whether or not the storage media are in the slots and the external storage and whether or not the respective storage media is in an accessible state. The exclusive controlling element 35 is also connected to a file system 36 and the host access controlling element 34, so that it perceives which storage medium the file system 36 requires to access as well as which storage medium the host access controlling element 34 requires to access, and, in response to the requests from the requesters, the exclusive controlling element 35 grants access to the requested storage media inserted in the slots or in the external storage unit. The exclusive controlling element 35 has a function of automatically switching to an accessible slot with insertion/removal of the storage media as a trigger, this function explained hereinafter.

The file system 36 is connected to the exclusive controlling element 35 and an image processing element 37, and it provides the image processing element 37 with a file access means having a general-purpose filing format such as FAT, and manages file information of the respective storage media.

The image processing element 37, connected to the file system 36 and a printing processing element 38, searches for image data stored in a storage medium as the subject data to be printed, and issues a request for printing the image data to the printing processing element 38 according to the user's commands. The image processing element 37 also checks, in accordance with the information from the printing processing element 38, the status of the printer 1, for example, whether the printer 1 is now printing or if any printing error has occurred. Moreover, the image processing element 37 has a function of saving image data stored in a storage medium loaded in any of the slots 17 to 19, on a storage medium loaded in the external storage unit 23, according to the user's commands.

The printing processing element 38 is a feature that conducts the printing process according to a print request sent from the image processing element 37, and comprises such elements as a recording head, a carriage motor, and a paper feed motor.

### [Switching of the Valid Slot]

Explanations will now be given for the exclusive access function of the exclusive controlling element 35, by means of automatic switching.

In the case of the printer 1 of the present embodiment that employs multi-slots, if an access was allowed to each storage media inserted in each slot at the same time, the user has to choose a slot in which a target storage medium is loaded every time the user sends a command for direct printing, and therefore, significantly complex operations by the user will be required. At the same time, the printer 1 also has to have a function of selecting one slot out of others that has a storage medium therein to which the printer has to access for the printing process. Development of a printer having such function will be complicated.

Thereupon, in this invention, it is configured that, among the slots and the external storage unit (hereinafter referred to as “slots”) having storage media loaded therein, only one of the slots can be a valid slot so that the number of storage media that can be accessed at one time is limited to one slot when printing directly. It is also configured in this invention that a slot that is validated to access a storage medium loaded therein (hereinafter referred to as a “valid slot”) automatically changes to another slot upon triggering by the insertion of a storage medium in another slot and by the removal of the storage medium from the current valid slot.

Specifically, when the exclusive controlling element 35 receives from among the slots a notification that a storage medium was inserted, it enables access to that slot. When more than one storage media is inserted into the slots at the same time, the exclusive controlling element 35 allows, according to the priorities given to each slot, access only to the slot having the highest priority and restricts (suspends) access to the other slots. The access to the other slots remains on hold until the storage medium in the valid slot is removed. When the exclusive controlling element 35 receives from the valid slot a notification that the storage medium was removed, and if there are other slots waiting to be accessed, the exclusive controlling element 35 allows access only to the slot that has the highest priority among the slots, and restricts (suspends) access to other slots as described. A valid slot is clearly distinguished by a lighted LED beside the slot (for example, LED flashes during access) so that the user can identify the valid slot, and the image file of the storage medium inserted in the valid slot is displayed on the control panel. The host device can recognize only the storage medium inserted in the valid slot.

With this function of automatic switching of the valid slot, the number of the storage media that can be accessed at one time is limited to one when printing directly from the storage media or when the printer is connected to the host device 26, thereby, making operations easier for the user to control and the user can use the printer without worrying which slot is valid. Moreover, it is possible to reduce the complexity of the development of the printer.

However, with this function of automatic switching of a valid slot, when a certain slot is valid and then a new storage medium is inserted into another slot, the valid slot does not switch to the newly-inserted slot until the storage medium in the currently valid slot is removed. The external storage unit 23 such as an MO drive is typically used to back up data of the first storage medium 14 or the like. Accordingly, in most cases, a storage medium such as an MO disk is at all times loaded in the external storage unit 23. However, a storage medium such as the first storage medium 14, is basically used for digital still cameras or the like. Accordingly, the storage medium is removed from the camera and inserted into the first slot 17 of the printer only when printing the photo image data. After the printing is completed, the storage medium is removed from the first slot 17 and inserted back into the camera.

Accordingly, because the automatic switching of a valid slot is triggered by the insertion and removal of the storage medium, the valid slot does not switch to a newly-inserted slot unless the storage medium in the currently valid slot is removed. Therefore, the user has to remove the storage medium in the external storage unit 23 each time, thus being greatly inconvenienced.

Therefore, it is preferable that the switching of the valid slot be conducted considering the respective purposes of each slot. In the present embodiment, the timing for switching the valid slot varies, depending on whether a storage medium is loaded in any of the slots 14 to 17 or in the external storage unit 23.

In other words, when the slots 17 to 19 have no storage medium inserted therein and the external storage unit 23 is the valid slot, if any of the storage medium 14, 15 or 16 is then inserted into any of the corresponding slots 17, 18 or 19, the exclusive controlling element 35 disables access to the external storage unit 23 and enables access to any of the corresponding slots 17, 18 or 19. In brief, the valid slot automatically switches from the external storage unit 23 to any of the slots 17, 18 or 19 when the storage medium is inserted into any of the slots 17, 18 or 19. Thus, the user does not have to remove the storage medium from the external storage unit 23.

If any of the storage medium 14, 15 or 16 is inserted into its corresponding slot 17, 18 or 19 when direct printing is being executed with regard to the external storage unit 23, the exclusive controlling element 35 suspends switching of the valid slot until the direct printing is over so that no error occurs.

### [Priority]

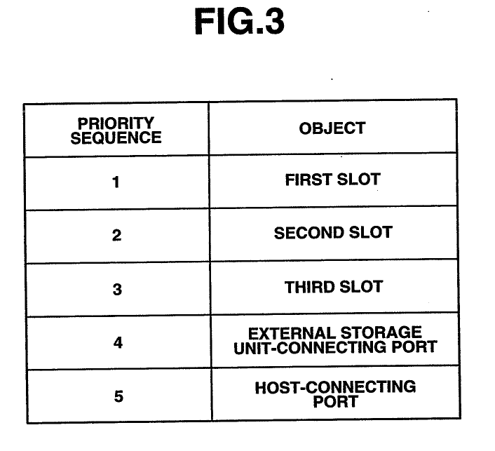

FIG. 3 shows priorities given to each interface (slots or ports) of the printer 1. In this embodiment, a port constituting an external interface is given a priority lower than the slots constituting internal interfaces. Specifically, priorities are determined in order starting with the first slot, then the second slot, the third slot, the external storage unit-connecting port, and finally the host-connecting port.

These priorities of the slots and ports, however, may be determined arbitrarily. The priorities can be preprogrammed in the printer 1, or it is also possible to provide the printer 1 with a setting unit so that the user can properly change the priority sequence. The determined priority sequence is stored in a specified storage area so that the exclusive controlling element 35 refers to the priority sequence when switching the valid slot.

[Operational Flow of Printer when Printing]

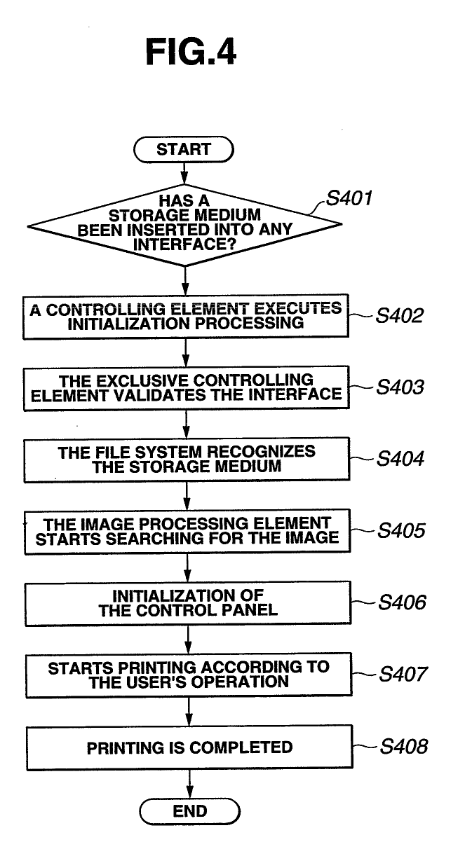

Hereinafter explained is the basic operational flow in the printing process by the printer 1 according to the present embodiment, with reference to FIG. 4. Explanations are given for the case where the slots (including the external storage unit) have no storage media loaded therein, and the user inserts a storage medium in a specified slot and gives a command for printing to the printer 1.

The respective controlling elements 30 to 33 monitor at all times whether a storage medium has been inserted into its corresponding interface (slot 17, 18 or 19, or the external storage unit 23, together hereinafter referred to simply as “slots”) (S401). When any of the controlling elements 30 to 33 detects that a storage medium was inserted into its corresponding slot, it executes the initialization processing for the inserted storage medium (S402), and notifies the exclusive controlling element 35 of the fact that the storage medium was inserted.

When the exclusive controlling element 35 receives a notification from any of the controlling elements 30 to 33, it enables an access to the corresponding slot (S403) and notifies that fact to the file system 36.

Upon receiving from the exclusive controlling element 35 the notification of the accessible slot, the file system 36 recognizes the storage medium inserted in the slot (S404), and further notifies that fact to the image processing element 37.

Upon receiving the notification from the file system 36, the image processing element 37 accesses the storage medium to search for the image data stored therein (S405).

When the search for the image data is completed, the image processing element 37 initializes the control panel (S406) and sends a command for printing the image data to the printing processing element 38 according to the user's input, then the printing processing element 38 starts printing (S407). Printing is then completed by the printing processing element 38 (S408).

[Operational Flow of Printer when Powering-on]

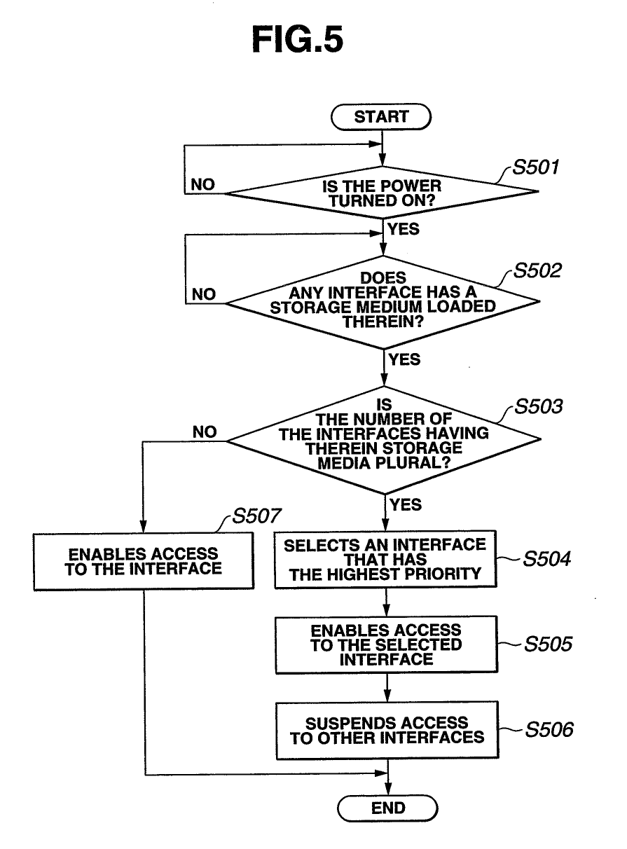

The explanations given here describe the operational flow of the printer 1 when the power of the printer is turned on, with reference to FIG. 5.

When the power of the printer 1 is turned on (S501), the exclusive controlling element 35 determines whether or not any slot has a storage medium loaded therein on the basis of the information from the respective controlling elements 30 to 33 (S502).

If the exclusive controlling element 35 determines that there is a slot that already has a storage medium loaded therein, it then determines whether the number of such slots is plural (S503). The exclusive controlling element 35 stores the information of the slots having therein storage media, in a specified storage area.

If the exclusive controlling element 35 determines that there are plural slots having a storage media, it refers to the specified storage area for information about the priorities of the slots in order to select the slot having the highest priority (S504). Then, the exclusive controlling element 35 enables access to the selected slot (S505) and suspends access to other slots that were not selected (S506).

However, if the exclusive controlling element 35 determines that there is only one slot that has therein a storage medium (the number of slots having storage media loaded therein is one), it enables access to the slot (S507).

Accordingly, if there are multiple slots that have storage media already loaded therein when turning on the printer, the slot having the highest priority becomes the valid slot. For example, if the first storage medium, the second storage medium and a MO disc are already loaded in the their respective slots (including the external storage unit), the first storage medium loaded in the first slot that is given the highest priority is validated.

[Operational Flow of Printer when Inserting Storage Medium]

The explanations given here describe the operational flow of the printer 1 when a storage medium is inserted into a slot after turning on the printer 1.

When the exclusive controlling element 35 receives, from any of the controlling elements 30 to 33, a notification that a storage medium was inserted (S601), it refers to a specified storage area to determine whether or not there is already a valid slot (whether or not the exclusive controlling element 35 itself has already allowed access to a different slot) (S602).

If the exclusive controlling element 35 has already determined that there is no valid slot, it enables access to the newly-inserted slot (S603) and stores that information in the specified storage area.

If, however, the exclusive controlling element 35 has determined that there is already a valid slot, it then determines whether the currently valid slot is an internal slot (S604). If it determines that the currently valid slot is an internal slot, it suspends access to the new slot (S605), on the principle that switching from an internal slot to another slot must not be done until a storage medium in the internal slot is removed.

If, however, the exclusive controlling element 35 has determined that the currently valid slot is not an internal slot, that is, the currently valid slot is an external slot, it then determines whether the new accessible slot is an internal slot (S606).

If the exclusive controlling element 35 has determined that the new slot is not an internal slot (i.e., the new slot is an external slot), it suspends access to the new slot, on the principle that the switching of the valid slot between external slots is not conducted until the storage medium in the currently valid slot is removed.

If, however, the exclusive controlling element 35 has determined that the new accessible slot is an internal slot, it then determines whether or not the currently valid external slot is under processing, that is, whether or not the currently valid slot has been accessed from a specified requester (S607). If the exclusive controlling element 35 determines that the currently valid external slot is under processing, it waits until the processing is over (S608). After the processing is completed, the exclusive controlling element 35 disables the access to the currently valid external slot and validates the newly accessible internal slot (S610).

If, however, the exclusive controlling element 35 determines that the currently valid external slot is not under processing, it immediately disables the access to the currently valid external slot (S609) and validates the newly accessible internal slot (S610).

[Operational Flow of Printer when Removing Storage Medium]

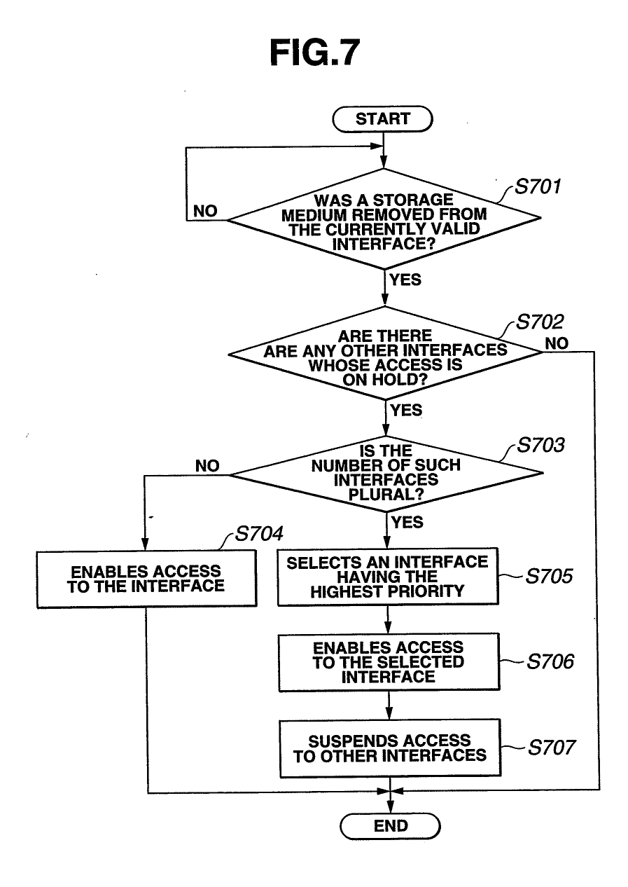

The explanations given here describe the operational flow of printer 1 when a storage medium is removed from a slot, with reference to FIG. 7. In the present invention, printer 1 changes the valid slot triggered by the insertion or removal of storage medium.

When the exclusive controlling element 35 receives a notification from any of the respective controlling elements 30 to 33 that a storage medium was removed, it stores that information in a specified storage area for storing the status of accessible slots.

Then, the exclusive controlling element 35 determines whether the removed storage medium is the one that was loaded in the currently valid slot (S701), and if it is determined that the storage medium was removed from the currently valid slot, it then determines whether there are any other slots whose access is on hold (S702).

If the exclusive controlling element 35 determines there is a slot whose access is on hold, it then determines whether the number of such slots is plural (S703). If the exclusive controlling element 35 determines that the number is not plural, it then enables an access to the slot to whose access is on hold (S704). However, if there are multiple slots to whose accesses are on hold, the exclusive controlling element refers to the specified storage are for information about the priorities of the slots, in order to select the slot having the highest priority (S705). Then, it enables access to the selected slot (S706) and continues to suspend access to other slots (S707).

As described, the provision of the multi-slots enables greater versatility for the printer in the present embodiment. Moreover, since the printer is configured in a manner that it automatically changes a valid slot by the triggering of the insertion or removal of a storage medium, every user can use the printer without worrying which slot is valid.

[Operation Flow when Backing-up]

The explanations given here describe the back-up process by the printer 1 in the present embodiment. As described, with the printer 1, the number of slots that can be accessed at one time is limited to one when printing directly. Accordingly, when any one of the slots 17 to 19 and the external storage unit 23 compete against each other for access, the printer 1 disables access to the external storage 23 even if it already has a storage medium loaded therein, and enables access to any of the slots 17 to 19.

However, when image data of a storage medium loaded in any of the slots 17 to 19 is to be backed up to another storage medium loaded in the external storage unit 23, it is necessary to obtain access both to any of the slots 17 to 19 and the external storage unit 23, so that the image data can be read from any of the slots 17 to 19 and be written to the storage medium in the external storage unit.

Thereupon, in this embodiment, access to the interfaces are optimally controlled according to the type of processing, that is, when printing directly, the number of slots that can be accessed at one time (slots that can be accessed for reading subject data to be printed) is limited to one. However, when backing up data, the number of slots that can be accessed at one time is limited to two. Specifically, it is controlled such that both accesses are enabled: access to a slot having subject data to be backed up so that the data can be read for backing up; and an access to a target slot having a storage medium in which the data is to be written.

In other words, when the data (subject data to be printed) in any of the storage media 14 to 16 loaded in the slots 17 to 19, is to be backed up to the storage medium 24 loaded in the external storage unit 23, access to such slot as well as the external storage unit 23 are enabled. Then, when the back-up process is completed, access to the external storage unit 23 is disabled but the access to any of the slots 17 to 19 having the loaded storage medium remains valid.

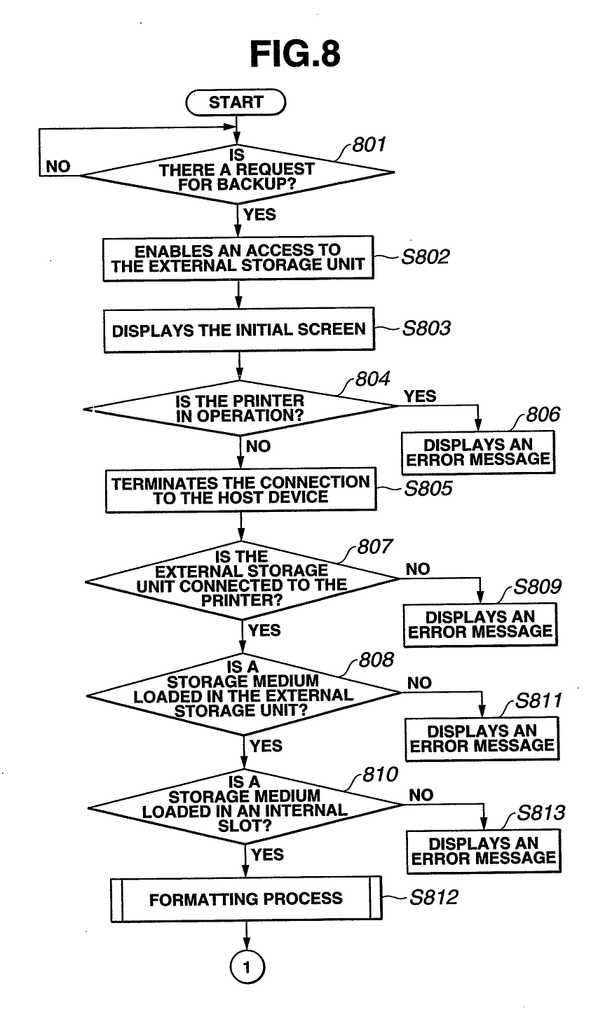

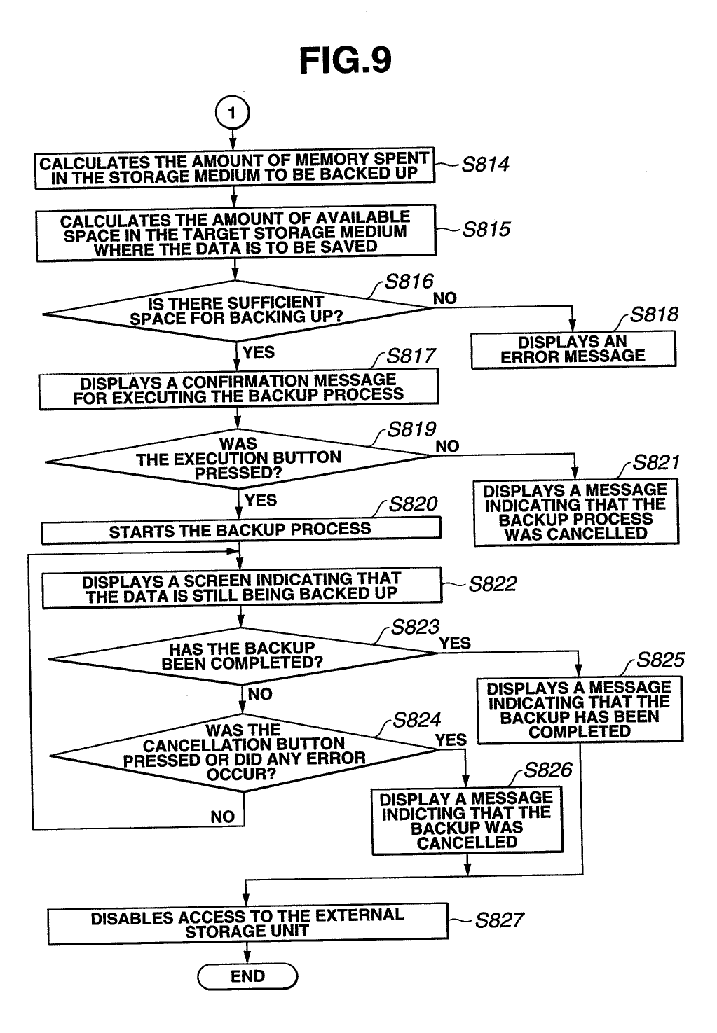

Explained hereinafter is a basic operational flow of the printer 1 according to this embodiment when backing up, with reference to FIGS. 8 and 9. In this embodiment, explanations will be given, as one example of the backing up, when after the image data of the third storage medium 16 loaded in the internal slot 19 is printed, the image data of the third storage medium 16 is backed up to the storage medium 24 loaded in the external storage unit 23. The third slot 19, having the third storage medium loaded therein, is set as the valid slot for printing directly.

After receiving a backup request from the user on the preferences menu screen 10 (S801), the image processing element 37 of the printer 1 notifies the exclusive controlling element 35 of such request. After receiving such notification from the image processing element 37, the exclusive controlling element 35 enables access to the external storage unit 23 while maintaining access to the third slot 19 having the third storage medium 16 loaded therein (S802).

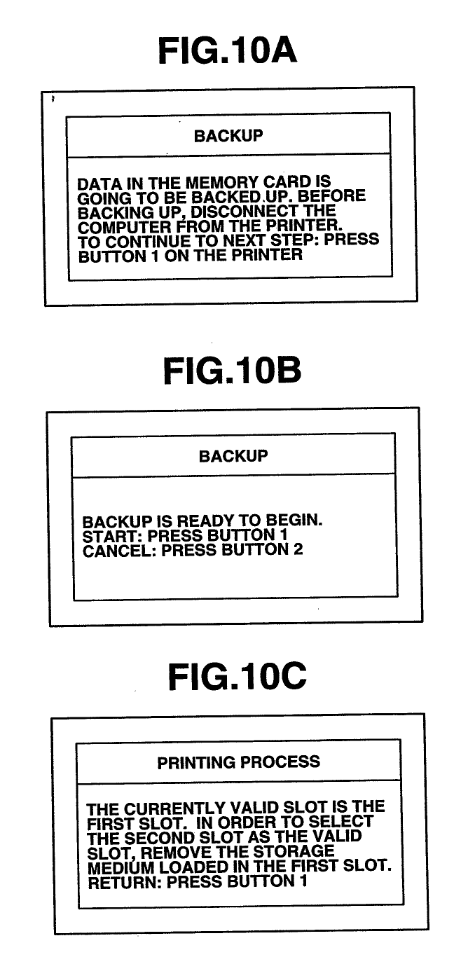

Next, the image processing element 37 displays, on the preferences menu screen 10, the backup mode initial screen (S803). As FIG. 10 (A) shows, in the backup mode initial screen, a message is displayed indicating that the connection to the computer (host device 26) must be terminated before backing up of the data can be done. In this embodiment, backing up is done based on the premise that the connection between the printer 1 and the host device 26 is terminated, to avoid writing to the first, second, and third storage media by the host device 26.

Then, the image processing element 37 determines whether or not the printer 1 is in operation, for example, whether or not the printing processing element 38 is directly printing (S804). If the image processing element 37 determines that the printer 1 is not in operation, it notifies the exclusive controlling element 35 that the connection to the host device 26 will be terminated. Upon receiving this notification, the exclusive controlling element 35 terminates the connection between the printer 1 and the host device 26 (S805). The state in which the connection between the printer 1 and the host device 26 is terminated, is the same as the state in which the cable 28 is disconnected from the host-connecting port 25. Accordingly, no access can be made from the host device 26 to the internal slot. However, if the image processing element 37 determines that the printer 1 is in operation, it displays an error message on the preferences menu screen 10 and cancels the backing up (S806).

Then, the image processing element 37 determines whether the external storage unit 23 is connected to the printer 1 (S807). If it has determined that the external storage unit 23 is connected to the printer 1, it then determines whether a storage medium is loaded in the external storage unit 23 (S808).

Specifically, the image processing element 37 inquires the external storage controlling element 33 through the file system 36, as to whether the external storage unit 23 is connected to the printer 1. When the external storage controlling element 33 receives the inquiry, it notifies the image processing element 37 through the file system 36 as to whether the external storage unit 23 is connected. The same processing procedure is followed when determining whether or not a storage medium is loaded in the external storage unit 23.

If the image processing element 37 determines that a storage medium is loaded in the external storage unit 23, it then determines whether another storage medium is loaded in any of the internal slots 17 to 19 (S810).

If the image processing element 37 determines a storage medium is loaded in any of the internal slots 17 to 19, it then determines whether the storage medium loaded in the external storage unit 23 is formatted. If it has determined that the storage medium is not formatted, it then formats the storage medium (S813).

In order to determine whether a storage medium is inserted in any of the slots 17 to 19, the image processing element 37 makes an inquiry, through the file system 36, to any of the controlling elements 30 to 32 that is controlling the currently valid slot. In this embodiment, the third slot 19 is a valid slot, accordingly, the image processing element 37 inquires the third slot controlling element 32. After receiving the inquiry from the image processing element 37, the third slot controlling element 32 notifies the image processing element 37 through the file 36 as to whether a storage medium is loaded in the third slot 19.

However, if the image processing element 37 determines that the external storage unit 23 is connected to the printer 1, or that the external storage unit 23 does not have a storage medium loaded therein, or that the internal slot does not have a storage medium loaded therein, it displays an error message on the preferences menu screen 10 and cancels the backing up (S809, S811, and S813).

After checking there are storage media necessary for executing the backup process, the image processing element 37 accesses the storage medium (the third storage medium 16 in this case) to be backed up, and computes the amount of data in the storage medium to be backed up (S814). Specifically, the image processing element 37 inquires, through the file system 36, to the third slot controlling element 32, how much space in the third storage medium 16 is used. After receiving the inquiry from the image processing element 37, the third slot controlling element 32 detects the amount of space used in the third storage medium 16 and notifies the amount to the image processing element 37 through the file system 36.

Next, the image processing element 37 calculates how much space is available in the other storage medium where the backup data is going to be written (S815). Specifically, the image processing element 37 inquires, through the file system 36, the external storage controlling element 33, how much space in the storage medium loaded in the external storage unit 23 is available. After receiving the inquiry from the image processing element 37, the external storage controlling element 33 detects the amount of space available in the storage medium loaded in the external storage unit 23 and notifies through the file system 36 the image processing element 37, how much space is available.

Based on the amount of space used in the storage medium to be backed up, and the amount of available space in the target storage medium where the backup data is going to be written, the image processing element 37 determines whether the available space in the target storage medium is larger than the amount of memory spent in the storage medium to be backed up, that is, it determines whether the available space is sufficient to back up the data (S816). If the image processing element 37 determines that the available space in the target storage medium is sufficient, it displays on the preferences menu screen 10 a confirmation message for beginning the backup of the data (S817). However, if it determines that the available space is insufficient, it displays an error message in the preferences menu screen 10 and cancels the backup (S818).

In the confirmation message as shown in FIG. 10 (B), the user can make a final decision whether or not to back up the data. The image processing element 37 determines whether the user selected an execution button (S819) and if it determines that the execution button was selected, it starts the backup process (S820).

Specifically, the image processing element 37 accesses the third slot controlling element 32 through the file system 36 to read the image data stored in the third storage medium 16. Then, the image processing element 37 accesses the external storage controlling element 33 through the file system 36 to write the image data it read on the storage medium 24 loaded in the external storage unit 23. However, if the user selects a cancellation button, the image processing element 37 displays on the preferences menu screen 10 a message indicating that the backup is going to be canceled and cancels the backup (S821).

The image processing element 37 determines whether all of the image data stored in the third storage medium 16 was backed up to the storage medium 24 loaded in the external storage unit 23 (S823), and if it determines that all of the data has been backed up, it displays on the preferences menu screen 10 a message indicating that backup has completed (S825).

If any specified error (S824) occurs, such as the cancellation button was selected during backup, the image processing element 37 displays on the preferences menu screen 10 a message indicting that the backup is going to be canceled, and cancels the backup process (S826). Examples of the specified errors include, other than the above case in which the cancellation button was selected, such cases as when the storage medium is removed from the slot, or when the cable 27 connecting the printer main body 2 and the external storage unit 23 is disconnected.

When the backup is completed or canceled, the image processing element 37 notifies this to the exclusive controlling element 35. The exclusive controlling element 35, upon receiving the notification from the image processing element 37, disables the access to the external storage unit 23 (S827).

In this embodiment, the printer 1 is controlled such that direct printing cannot be done during backup. Correspondingly, backup cannot be done during direct printing. Accordingly, there is no decline in the speed of direct printing because backup cannot be done during direct printing.

Specifically, during backup, the exclusive controlling element 35 disables accesses to the internal slots 17 to 19 and the external storage unit 23 for printing (access for reading the subject data to be printed), while enabling access to the same slots for backup (access for reading and writing the subject data to be saved).

As explained, upon receiving a backup request from the user, the printer 1 according to this embodiment enables access to the external storage unit 23 while maintaining valid access to any of the internal slots 17 to 19. Therefore, the user can smoothly back up the image data that was directly printed, to the storage medium 24 loaded in the external storage unit 23.

The printer 1 of the present invention is convenient for the user since it automatically disables access to the external storage unit 23 when backup is completed. The user does not have to remove the storage medium 24 from the external storage unit 23.

### Other Embodiments

In the aforementioned embodiment, the operations by the printer 1 were explained sequentially. However, the order of the operations is not limited to the above case, but can be rearranged or some steps may occur in parallel, as long as there are no inconsistencies in the operation of the printer 1.

The above-described embodiment is for exemplifying the example of the present invention and is not to intended to limit the scope of this invention to this embodiment. So as long as the gist of the invention is not deviated, the present invention may be worked in various forms and manners.

### [Other Examples of Switching the Valid Slot]

In the aforementioned embodiment, when a storage medium is already loaded in an external slot (the external storage unit) and then another storage medium is inserted into an inner slot, the valid slot is switched from the external slot to the internal slot while the storage medium is still loaded in the external slot. However, the switching of the valid slot is not limited to such case, but can be properly arranged according to the intended purposes of the storage medium or the configurations of the slots (interfaces). For example, in the case where an internal slot A is provided for storing data, the switching timing of the valid slot may be configured so that when a storage medium is inserted to an internal slot B, the valid slot switches from the internal slot A to the internal slot B. Furthermore, the priority of the external slot is set lower than those of the internal slots in the above embodiment. However, it is also possible to change the priorities so that the external storage-connecting port 22 will have the highest priority (a priority higher than the priorities of the internal slots) when a digital still camera is connected to the printer 1 through the external storage-connecting port 22, for example.

[When there is More than One External Storage Unit]

The aforementioned embodiment was described by taking as an example a case where one external storage unit 23 is connected to the printer 1 through the external storage-connecting port 22. However, it is also possible to connect a plurality of external storages units 23 to the printer 1 through a hub. For example, other than an MO drive, a ZIP drive, a digital still camera, and a memory card reader/writer can be connected to the printer 1. In this case, for example, priorities are given to respective ports provided in the hub, and if storage media are loaded in the plural external storages respectively, the valid slot is determined in accordance with the priorities of the ports. As for the switching of a valid slot among the external storages, when the storage medium loaded in a currently valid external storage is removed, the valid slot switches from the external storage to another external storage that has a storage medium loaded therein, just as in the case of the switching between internal slots.

### [Confirmation Messages]

With the above-described function of automatically switching the valid slot, in the case where a particular slot or the like is currently valid, if another storage medium is inserted to another slot, the valid slot does not switch to the newly-inserted slot until the storage medium in the currently valid slot is removed. With this configuration, however, the currently valid slot is not always the slot intended by the user. Accordingly, if a particular slot is a valid slot and when a storage medium is inserted to another slot, a specified message as shown in FIG. 10 (C) is preferably displayed on the preferences menu screen 10. If the user checks the message on the screen and removes the storage medium from the currently valid slot, the slot intended by the user will become the valid slot.

### [Granting the Right to be Accessed to Storage Medium]

The present invention may be configured such that, instead of determining only one slot as the valid slot, a right to be accessed is given to a storage medium loaded in a specified slot, according to the priorities given to the other slots or to the storage media. With this configuration, access can be made only to the storage medium having the right to be accessed. Accordingly, the number of storage medium that can be accessed at one time for direct printing can be limited to one. Specifically, when more than one slots have storage media loaded therein, the exclusive controlling element 35 grants a right to be accessed to a storage medium loaded in one slot. Only the storage medium to which the right to be accessed was granted can accept an access request from a specified requestor. For example, the image data of the storage media having the right to be accessed is displayed on the control panel, and the host device can recognize only the storage medium having the right to be accessed. Furthermore, the exclusive controlling element 35 can properly determine the content of rights to be accessed that will be given to storage media. For example, rights to be accessed may comprise a right to accept an access for reading data and a right to accept an access for writing data, so that each right can be provided to different storage media.

The present invention relates to the following Japanese Patent Applications. In the designated countries where incorporation of cited documents as references is approved, the disclosures of the following applications are incorporated in the present invention by reference and shall be deemed as a part of the disclosure of the present invention.

### Japanese Patent Application 2002-070809 (Filed on Mar. 14, 2002)

### Japanese Patent Application 2002-139012 (Filed on May 14, 2002)

### EFFECTS OF THE INVENTION

According to the present invention, it is possible to provide a printer having greater versatility and usability by employing multi-slots.

### DESCRIPTION OF REFERENCE NUMERALS

1 PRINTER
14, 15, 16, 24 STORAGE MEDIA
17, 18, 19 SLOTS
22 EXTERNAL STORAGE UNIT-CONNECTING PORT
23 EXTERNAL STORAGE UNIT
25 HOST-CONNECTING PORT
26 HOST DEVICE
30 to 33 CONTROLLING ELEMENTS
34 HOST ACCESS CONTROLLING ELEMENT
35 EXCLUSIVE CONTROLLING ELEMENT
36 FILE SYSTEM
37 IMAGE PROCESSING ELEMENT
38 PRINTING PROCESSING ELEMENT

I claim:

1. A printer comprising:
a plurality of interfaces for respectively accessing a plurality of storage media having subject data to be printed stored therein;
an exclusive controlling element for determining, when access can be made to storage media loaded in two or more interfaces out of the plurality of interfaces, one interface out of the two or more interfaces as a valid interface;
an image processing element for reading subject data to be printed from a storage medium loaded in the valid interface determined by the exclusive controlling element; and
a printing processing element for printing the subject data that was read by the image processing element.
